(19) United States
(12) Patent Application Publication
(10) Pub. No.: US 2019/0288740 A1
(43) Pub. Date: Sep. 19, 2019

(54) Electromagnetic Communication Device

(71) Applicant: Elmer Griebeler, Chesterfield, OH (US)

(72) Inventor: Elmer Griebeler, Chesterfield, OH (US)

(21) Appl. No.: 16/422,582

(22) Filed: May 24, 2019

Related U.S. Application Data
(63) Continuation-in-part of application No. 14/617,461, filed on Feb. 9, 2015, now abandoned.

(51) Int. Cl. H04B 1/719; H04B 1/717; H04B 1/7163; H04B 1/7176

(52) U.S. Cl. CPC H04B 1/719; H04B 1/7176; H04B 1/71635; H04B 1/7172

(57) ABSTRACT

A communication apparatus using electromagnetic pulses comprising a signal generating means for generating and transmitting data in at least one non-oscillating electromagnetic pulse as a communication signal; a signal processing means for receiving at least one non-oscillating electromagnetic pulse, and processing the one or more pulses to derive useful information; at least one antenna for sending and/or receiving signals; a time keeping means for providing time spacing variation for transmitting said pulses; a time spacing pattern library for providing known spacing patterns; a comparator for comparing a received signal with signals from said spacing pattern library to thereby identify the communication pulse, whereby the communication pulse can be distinguished from sparks, radio, and background noise.

### CROSS REFERENCE TO RELATED APPLICATIONS

This application is a continuation-in-part of, and claims the benefit of, U.S. patent application Ser. No. 14/617,461, filed Feb. 9, 2015, which is entitled “Electromagnetic Pulse Device,” and is incorporated herein by reference.

### BACKGROUND OF THE INVENTION

The present invention is directed to a device that uses a unique pattern of pulse spacing in a novel way to transmit data without interference with conventional radio and to effectively add an alternative to the crowded radio spectrum.

Radio waves are continuous resonances or oscillations, or short duration pulses or bursts of oscillations such as with radar, for example. Spikes or pulses from electrical sparks and lightning are examples of electromagnetic pulses. Electromagnetic spikes are usually subject to a decaying resonance due to complex impedance encountered in electrical circuits similar to a bell ringing, fading to silence. It is essentially a damped sinusoidal wave whose amplitude approaches zero as time increases. For the purpose of pulse mode communication, antenna resonances needed to be suppressed with critical damping or designed to naturally not resonate.

### SUMMARY OF THE INVENTION

The present invention is directed to a communication apparatus using electromagnetic pulses comprising a signal generating means for generating and transmitting data in at least one non-oscillating electromagnetic pulse as a communication signal; a signal processing means for receiving at least one non-oscillating electromagnetic pulse, and processing the one or more pulses to derive useful information; at least one antenna for sending and/or receiving signals; a time keeping means for providing time spacing variation for transmitting said pulses; a time spacing pattern library for providing known spacing patterns; a comparator for comparing a received signal with signals from said spacing pattern library to thereby identify the communication pulse, whereby the communication pulse can be distinguished from sparks, radio, and background noise.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic of a communication signal transmitter;

FIG. 2 is a schematic of a communication signal receiver; and

FIG. 3 is an example of a time-spacing code.

### DETAILED DESCRIPTION OF THE INVENTION

The present invention is to the use of a system and apparatus for communication using pulses, and includes pulse spacing control and recognition, and signal averaging in the receiver. The radio spectrum is full. Pulse-based communication is an alternative that can open a new spectrum and thereby relieve the present radio spectrum crowding. Radio allows many simultaneous communications by using separate frequencies; this can be referred to as frequency domain. Pulse communication allows many simultaneous communications (channels) by using different pulse spacing codes of different lengths; this can be referred to as time domain. Discrete pulses (representing bits) are used which lack frequency content. The pulse starts as a logic level timed signal.

The transmitting electronics create a series of voltage pulses. This invention offers a class of electromagnetic pulses that do not occur in nature nor are they used in radio communications.

The pulse has no oscillations, and therefore, no frequency (although a series of pulses theoretically can be created from a unique set of sine waves). This series of electromagnetic pulses use spacing variations in a pattern that allows these pulses to be easily distinguished from sparks, radio, and background noise.

An antenna converts the voltage pulse into an electromagnetic pulse (EMP). An appropriate power supply is provided for all the components, although independent power supplies may be provided with the antennas.

One way to clarify what is meant herein by “pulse” is to consider a pulse like a shockwave, or like a hammer hitting rock which produces no sound oscillations, as opposed to a hammer hitting a bell which produces oscillations at a definite pitch or frequency. A struck rock produces a single sound spike, whereas the bell will reverberate and produce the characteristic bell ringing sound. There is a great advantage in not producing oscillations since oscillations obscure details like data content. Radio waves, microwaves, visible light, x-rays, and gamma rays are all electromagnetic oscillations.

This is not to suggest that the pulse is not a “wave” since a wave can be a spike or an oscillation. An example of a spike is a shockwave or soliton wave; neither has oscillations. Contrast this with the everyday oscillating radio waves; radio waves and this spike are both electromagnetic, but they are not the same. A poorly chosen pulse spacing pattern can cause interference with radio anywhere from the clock frequency all the way down to low frequency navigation used by ships. This invention avoids interference with radio of any frequency of value to radio. The pulse spacing pattern repeats at the lowest rate practical, typically 100,000 times per second where there is no radio usage. Of special note, even the clock frequency will be visible in a radio spectrum scan even though there is nothing visible of the clock in the pulse pattern. This happens because the pulses land on the hidden cycles of the clock. The solution of this invention is to use the pulse spacing code to slightly change the spacing of the clock cycles. If the receiver is set up to expect this, the receiver will have no problem recognizing the transmission.

The time signal is converted to a logic level pulse width by a logic device such as, for example, a 74123 IC logic chip, which can create adjustable width logic level pulses. Logic level is established and well known in the electronics industry, where typically a one (1) is represented by five volts and a zero (0) is represented by zero volts. These logic level pulses are amplified by a gate driver which turns a power transistor on and off to create the power pulse that is in turn sent to the antenna. The pulses can be much higher power than the average power so that the pulses stand out above the ambient noise at greater range than radio at the same average power. The average power is the sum of the power over time, usually over one second. With pulses, there is high power in the pulses and no power in between the pulses, so the pulse power is the actual power supplied by a power source such as a battery. This is done by a battery slowly charging a storage device, such as a capacitor, and rapidly discharging into the pulses.

The receiver averages many repeats of the time spacing pattern to reject other patterns and to increase the signal strength above ambient noise. An example arrangement is an average of one million pulses per second with 1000 repeats with a spacing code length of ten pulses. The pulses are typically 10 ns (0.000,000,01 second). 1 million pulses/s is a pulse every 0.000,001 second. I.e. 10 ns pulse followed by 990 ns of quiet). The pulses come in long strings with spacing according to the “time spacing pattern” for the purpose of recognition by the receiver. For typical applications, this string forming the entire “time spacing pattern” would represent one bit of data. The signal does weaken by the inverse square law, just like radio signals. The amplifier in the receiver raises the signal amplitude back up, but also amplifies noise. An averager accumulates and strengthens the signal and at the same time suppresses the noise which naturally averages toward zero due to its randomness and lack of correlation with the pattern of the signal. This greatly extends the range of this pulse technology.

Pulse communication needs to work as well or better than radio; this includes the number of available channels, and range (which includes distance at a given power level and data rate).

There are a variety of pulse shapes possible. Using different pulse shapes rejects other signals with the same time-spacing-pattern. The time-spacing-pattern is “phase locked” in the receiver to find the beginning and end of the time-spacing-pattern. This rejects time-spacing-patterns of other lengths. The time-spacing-pattern can have many forms. The form of the time-spacing-pattern will attenuate or reject a signal with another form. The time-spacing-pattern can have any number of forms so that the data can be encoded in unique ways, such as different form representing the bits in a byte or word. The presence of a form could represent a one; the absence of a form could represent a zero, in each of the bit positions within a byte or word.

In order to be a feasible method of communication, pulse communication must not interfere with radio. The pulse spacing codes must not include any repeating patterns where the rate of any repeats is a frequency of value in the radio spectrum. The pulse contains no frequency but regularly repeating pulses will manage to cause a weak response in a radio at the pulse repeat rate (pulses per second=frequency). The pulse time spacing varies according to a pattern that repeats at a rate below any radio frequency of value (time-spacing-pattern). The time-spacing-pattern contains within it no intervals of the same time (i.e. no regular pattern). This eliminates any frequency content in the time-spacing-pattern above the repeat rate.

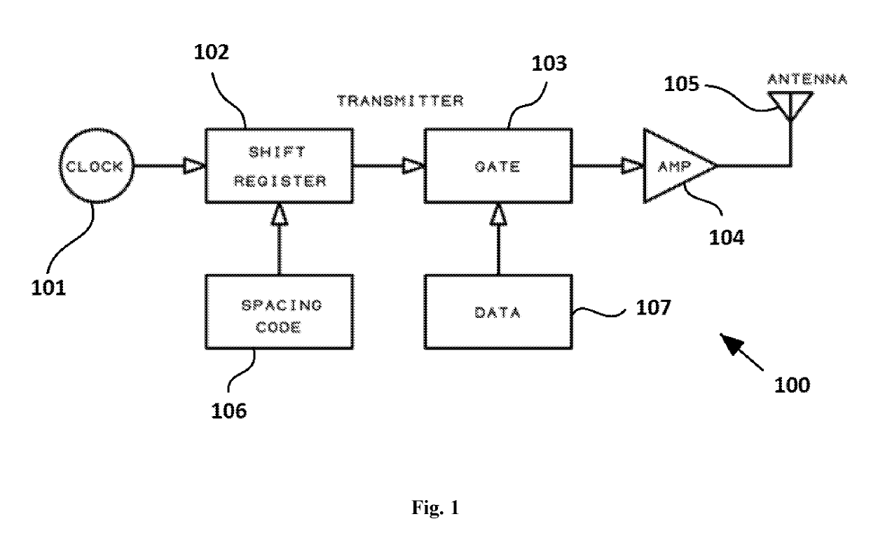

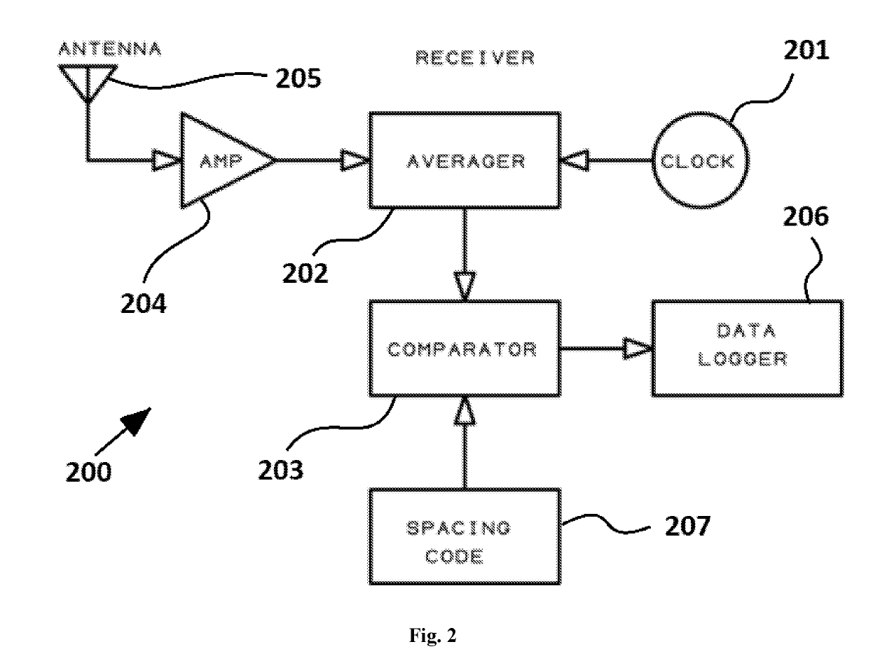

FIGS. 1 and 2 show the transmit clock 101 and receive clock 201, which are precision crystal controlled oscillators of the same frequency. The clock frequency is chosen as needed to form the time spacing pattern. Most importantly, the clock frequency can have a clock cycle spacing pattern for higher avoidance of interference with radio. The clock frequency is determined by the product of: (the spacing pattern repeat rate)×(the length of the spacing pattern)×(resolution of the spacing pattern)×(length of the clock cycle spacing pattern)×(the resolution of the clock cycle spacing pattern). A typical frequency could be 65 MHz. The frequency is chosen by the available electronics, by the size of the antennae, and by the distance that needs to be covered. Modern electronics can handle up to about 40 GHz, but this would limit range to line of sight. 65 MHz will go around most structures and therefore have useful range up to hundreds of miles. If 5 MHz is used, the pulses will follow the curvature of the Earth and could be received on the other side of the Earth without using any supporting technology such as cable or satellites. The clock is different for different applications or for different communication tasks.

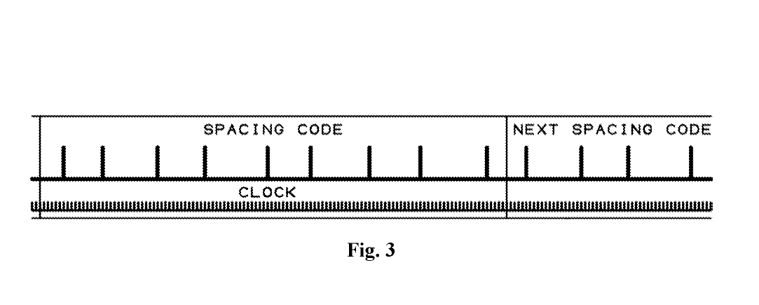

The spacing pattern repeat rate, etc. are all selectable for security or to establish different transmission tasks. The transmit shift register 102 takes one value at a time of the spacing code 106 (See also, FIG. 3) and is used to delay the next pulse. These logic level pulses are amplified by a gate driver 103 which turns a power transistor on and off to create the power pulse that is in turn sent to the amplifier 104. Data 107 is introduced into the pulse at the gate 103._There are several ways that data can be incorporated. For high data rate, which limits the range, the data can be included within the pulse spacing code by, for instance, leaving out a pulse to indicate a zero. To be practical, and for long range transmission, a large number of repeats of the pulse spacing pattern could represent a one, and a large number of repeats of an alternative time spacing pattern or no transmission for a time equal to the large number of repeats, providing the zero. The amplifier 104 converts the pulses to the desired shape which is transmitted by the antenna 105.

The receiver 200 picks up the weak signal with its antenna 205. The receiver amp 204 increases the signal strength. The averager 202 accumulates an average of the signal in cells at the rate of the precision clock 201. In order for the receiver to pick up the transmitter's signal, its clock 201 must match the frequency of the transmitter clock 101. One method to synchronize the receiver clock to the transmitter clock is to use a phase lock loop circuit, which intentionally leaves the receiver's clock slightly out of sync. This causes the pattern of the transmitted signal to slowly drift with respect to a recognition circuit in the receiver that is looking for the pattern.

When the pattern momentarily aligns with the receiver recognition circuit, the clock frequency is adjusted slightly to maintain the alignment to hold the frequency at the perfect value in an on-going effort by the circuit to maintain the lock. When the two patterns happen to shift into alignment, the clock is slowed down a little to stop the drifting of the received pattern. Then there is an ongoing effort by this locking circuit to maintain the alignment. This phase locking circuitry is well known in the communication industry. If the circuit should unlock, once again the receiver's clock would run slightly fast until lock is re-established. One method of sending data is to send one pattern for a data bit of one and a different pattern for a data bit of zero. This does require that the patterns are the same length in time and when one ends, the other starts. There would be two comparators, one for each pattern, and each would trim the receiver's clock as needed to maintain lock.

The number of signals averaged is a preset number. The number of signals averaged can be parts of the communication address or be an adaptive algorithm such as the BAUD rate control used in most all computers for communication to printers, for example. The number of signals averaged can be 10, 100, or 1 million, depending on how weak the received signal is due to distance between the transmitter and receiver. Distance is the major determination of the number of signals that need to be averaged; the more distance or the weaker the transmitter, the more number of repeats of the signal that need to be averaged. This process does slow the rate that data can be sent. Further, the laws of nature dictate that radio and pulse mode are the same at corresponding frequency. However, pulse has the advantage that the pulses can have a data rate as high as the pulse rate whereas radio must have a data rate much lower to avoid encroaching on adjacent frequencies.

The pulse mode can transmit any digital signal. In this way, it performs functions similar to a standard radio transmitter. Once the signal is received, it is processed as one would process a typical radio signal to derive the message or useful data. It can be used to transmit, for example, simple binary code, text, images, and video. However, if the transmit power is very low or the distance large, video will update slowly and look jerky. The comparator 203 compares the accumulated signal with the same spacing code 207 that the transmitter uses. The time spacing code or pattern is held in a library that is actively available to the comparator. The time spacing code would be specific to a receiving device. The transmitter would, ahead of time, know the receiver's spacing code; this is similar to a telephone number. For startup purposes, the beginning of the averaging is slowly shifted for best match with the spacing code. If the spacing code matches, the signal is accepted as a binary one (1) and stored in the data logger 206. If the spacing code 207 is missing after the preset number of averages, a zero (0) is stored in the data logger. In this way data is sequentially received and stored in the data logger.

Spacing Code

Data bits can be indicated by a unique time-spacing-pattern/code that represents a one, and another time-spacing-pattern that represents a zero, as shown in FIG. 3. The number of repeats of each time-spacing-pattern must be sufficient for the time-spacing-pattern averaging to rise above noise in the receiver, taking into consideration the transmission distance. The data rate is very fast, as fast as the time-spacing-pattern repeat rate. For example, if one has about 1 million pulses per second, and a time spacing pattern (code) that is ten pulses long, the pattern repeats 100,000 times per second. If one is averaging 1000 patterns to get better reception, the data rate would be 100 bits per second. The time-spacing-pattern is repeated or followed by the alternative pattern, as needed to convey the binary series of ones and zeroes. The string of data bits form characters, which form words which form sentences, or they could be pixels that form an image.

Data bits can be indicated by the presence of an expected time-spacing-pattern which could represent a one; a zero would then be represented by a pause or lack of the expected time spacing pattern for a corresponding amount of time, or a different time-spacing-pattern. For broadcast applications, different time-spacing-patterns can provide a large number of separate potential broadcast “stations.”

One possible spacing code is a string of pulses with spacings that are t×(1+count reverse/1024) for a 10 bit counter, where “t” is a unique spacing code incrementing time to produce separate channels. This spacing code is created by allowing 10 bits to count up to 1023 and reversing the bit sequence. For 15 nano-seconds average spacing the timing is as follows:

| | | Binary | Count | | Pulse |
|---|---|---|---|---|---|
| Count | Binary | Reversed | Reversed | 1 + CR/1024 | Spacing |
| 0 | 00 0000 0000 | 00 0000 0000 | 0 | 1.000 | 10.00 ns |
| 1 | 00 0000 0001 | 10 0000 0000 | 512 | 1.500 | 15.00 ns |
| 2 | 00 0000 0010 | 01 0000 0000 | 256 | 1.250 | 12.50 ns |
| 3 | 00 0000 0011 | 11 0000 0000 | 768 | 1.750 | 17.50 ns |
| . . . | . . . | . . . | . . . | . . . | . . . |
| 1021 | 11 1111 1101 | 10 1111 1111 | 767 | 1.749 | 17.49 ns |
| 1022 | 11 1111 1110 | 01 1111 1111 | 511 | 1.499 | 14.99 ns |
| 1023 | 11 1111 1111 | 11 1111 1111 | 1023 | 1.999 | 19.99 ns |

So, in the above example, the pulses would be sent at 10 ns, 15 ns, 12.5 ns, 17.5 ns . . . In other words, pulse 1 is sent, then wait 10 ns, then pulse 2 is sent, wait 15 ns, pulse 3 sent, wait 12.5 ns, then pulse 4 is sent, etc.

The equipment is sufficiently precise, and is able to recognize pattern spacing better than 0.01 ns. Clocks are available with this resolution and stability.

For ease of visualizing, a three bit code generator is presented: (Here, 8 was chosen for this chart because it is a small pattern that can be easily printed here.)

| | | Binary | Count | | Pulse |
|---|---|---|---|---|---|
| Count | Binary | Reversed | Reversed | 1 + CR/8 | Spacing |
| 0 | 000 | 000 | 0 | 1.000 | 10.00 ns |
| 1 | 001 | 100 | 4 | 1.500 | 15.00 ns |
| 2 | 010 | 010 | 2 | 1.250 | 12.50 ns |
| 3 | 011 | 110 | 6 | 1.750 | 17.50 ns |
| 4 | 100 | 001 | 1 | 1.125 | 11.25 ns |
| 5 | 101 | 101 | 5 | 1.625 | 16.25 ns |
| 6 | 110 | 011 | 3 | 1.375 | 13.75 ns |
| 7 | 111 | 111 | 7 | 1.875 | 18.75 ns |

Alternative Methods
1) The spacing code can be alternated with a different spacing code to indicate the ones and zeroes.
2) The pulses in the spacing code could alternate plus and minus. This is the natural result of a voltage switching high and low after passing through a device like an antenna that has a limit to its reaction time.
3) The pulses in the spacing code could be a mixture of plus and minus pulses to form unique identification codes or to indicate the ones and zeroes of the data to be transmitted. This provides a high data rate.
4) The pulses in the spacing code can have different shapes. Two examples are a sudden voltage rise with a slower fall back to zero, and a slower voltage rise with a sudden fall back to zero. Such shapes can be used in the spacing code in unique sequences to form separate channels or to indicate the ones and zeroes of the data to be transmitted.
5) The pulses in the spacing code can have two different shapes to indicate the ones and zeroes of the data to be transmitted. This provides a high data rate.

Although the invention has been described in detail with reference to particular examples and embodiments, the examples and embodiments contained herein are merely illustrative and are not an exhaustive list. Variations and modifications of the present invention will readily occur to those skilled in the art. The present invention includes all such modifications and equivalents. The claims alone are intended to set forth the limits of the present invention.

What is claimed is:

1. A communication apparatus using electromagnetic pulses comprising:
A. a signal generating means for generating and transmitting data in at least one non-oscillating electromagnetic pulse as a communication signal;
B. a signal processing means for receiving at least one non-oscillating electromagnetic pulse, and processing the one or more pulses to derive useful information;
C. at least one antenna for sending and/or receiving signals;
D. a time keeping means for providing time spacing variation for transmitting said pulses;
E. a time spacing pattern library for providing known spacing patterns;
F. a comparator for comparing a received signal with signals from said spacing pattern library to thereby identify the communication pulse, whereby the communication pulse can be distinguished from sparks, radio, and background noise.

2. An electromagnetic communication apparatus comprising:
an electromagnetic pulse generating means for transmitting a signal,
an electromagnetic pulse recognizing means for receiving a signal;
a pulse spacing means to avoid interference with continuous wave radio frequencies,
a means to synchronize a transmitter and a receiver with the pulse spacing means;
a means to average many received pulse spacing patterns together for improved signal-to-noise ratio;
a means to incorporate data into a pulse stream; and
at least one antenna for sending and receiving electromagnetic pulses.

3. The apparatus of claim 1 further having a preprogrammed means for storing and analyzing return signals.

4. The apparatus of claim 1 further comprising processing a received communication pulse to derive useful data.

5. A communication apparatus using electromagnetic pulses comprising:
A. a signal processing means for receiving at least one non-oscillating electromagnetic pulse, and processing the one or more pulses to derive useful information;
B. at least one antenna for receiving signals;
C. a time spacing pattern library for providing known spacing patterns;
D. a comparator for comparing a received signal with signals from said spacing pattern library to thereby identify the communication pulse, whereby the communication pulse can be distinguished from sparks, radio, and background noise.
